(19) United States
(12) Patent Application Publication
(10) Pub. No.: US 2016/0007370 A1
(43) Pub. Date: Jan. 7, 2016

(54) Smart Power Monitor Scheduling to Improve Throughput Performance in a MSMA Phone

(71) Applicant: QUALCOMM INCORPORATED, SAN DIEGO, CA (US)

(72) Inventors: Ravi Kanth Kotreka, Hyderabad (IN); Harinath Reddy Patel, Hyderabad (IN); Mahender Reddy Akkapally, Madeenaguada (IN); Raghavendra Shyam Anand, Chickballapur (IN)

(21) Appl. No.: 14/321,156

(22) Filed: Jul. 1, 2014

(51) Int. Cl. H04W 72/12; H04W 88/06

(52) U.S. Cl. CPC H04W 72/1215; H04W 88/06

(57) ABSTRACT

Various embodiments provide methods implemented by a processor executing on a mobile communication device (e.g., a multi-SIM-multi-active communication device) to opportunistically schedule a victim subscription's power monitoring activities to occur during periods in which the aggressor subscription is already scheduled not to transmit, thereby reducing the amount of time the aggressor subscription must perform Tx blanking to accommodate the victim subscription's idle-standby-mode operations. Specifically, the victim subscription's monitoring activities may be scheduled to occur while the aggressor subscription is operating in a compressed mode. As a result, the overall throughput/performance of an aggressor subscription is improved as the aggressor experiences relatively fewer blanked transmissions without affecting the victim subscription's ability to perform power-monitoring operations.

### BACKGROUND

Some new designs of mobile communication devices—such as smart phones, tablet computers, and laptop computers—contain two or more Subscriber Identity Module (“SIM”) cards that provide users with access to multiple separate mobile telephony networks. Examples of mobile telephony networks include GSM, TD-SCDMA, CDMA2000, LTE, and WCDMA. Example multi-SIM mobile communication devices include mobile phones, laptop computers, smart phones, and other mobile communication devices that are configured to connect to multiple mobile telephony networks. A mobile communication device that includes a plurality of SIMs and connects to two or more separate mobile telephony networks using two or more separate radio-frequency (“RF”) transceivers is termed a “multi-SIM-multi-active” (MSMA) communication device. An example MSMA communication device is a “dual-SIM-dual-active” (DSDA) communication device, which includes two SIM cards/subscriptions associated with two mobile telephony networks.

Because a multi-SIM-multi-active communication device has a plurality of separate RF communication circuits or “RF chains,” each subscription on the MSMA communication device may use its associated RF chain to communicate with its mobile network at any time. However, in certain band-channel combinations of operation, the simultaneous use of the RF chains may cause one or more RF chains to desensitize or interfere with the ability of the other RF chains to operate normally because of the proximity of the antennas of the RF chains included in the MSMA communication device.

Generally, receiver desensitization (referred to as “de-sense”), or degradation of receiver sensitivity, may result from noise interference of a nearby transmitter. For example, when two radios are close together with one transmitting on the uplink—sometimes referred to as the aggressor communication activity (“aggressor”)—and the other receiving on the downlink—sometimes referred to as the victim communication activity (“victim”)—signals from the aggressor's transmitter may be picked up by the victim's receiver or otherwise interfere with reception of a weaker signal (e.g., from a distant base station). As a result, the received signals may become corrupted and difficult or impossible for the victim to decode. Receiver de-sense presents a design and operational challenge for multi-radio devices, such as MSMA communication devices, due to the necessary proximity of transmitter and receiver.

### SUMMARY

Various embodiments provide methods, devices, and non-transitory processor-readable storage media for scheduling power-monitoring operations of a second subscription to improve performance of a first subscription.

Some embodiment methods may include identifying an upcoming compressed-mode gap of the first subscription and scheduling the second subscription to perform power-monitoring operations during the upcoming compressed-mode gap of the first subscription.

In some embodiments, the first subscription may be operating in an active mode, and the second subscription may be operating in an idle-standby mode.

In some embodiments, the first subscription may utilize a WCDMA radio access technology (RAT) to communicate with a WCDMA mobile network, and the second subscription may utilize a GSM RAT to communicate with a GSM mobile network.

In some embodiments, the first subscription may utilize an Orthogonal Frequency-Division Multiple Access (OFDMA) or an LTE radio access technology (RAT) to communicate with an LTE mobile network, and the second subscription may utilize a GSM RAT to communicate with a GSM mobile network.

In some embodiments, the first subscription may utilize a first radio access technology (RAT) to communicate with a first mobile network, the second subscription may utilize a second RAT to communicate with a second mobile network, and the first RAT may be different from the second RAT.

In some embodiments, identifying an upcoming compressed-mode gap of the first subscription may include determining a start time of the upcoming compressed-mode gap of the first subscription, and scheduling the second subscription to perform power-monitoring operations during the upcoming compressed-mode gap of the first subscription may include identifying a second paging-reception period of the second subscription that is scheduled to occur after a first paging-reception period of the second subscription—in response to determining that the first paging-reception period is about to start—determining a start time of the second paging-reception period, determining whether the start time of the second paging-reception period is later than the start time of the upcoming compressed-mode gap of the first subscription, and scheduling the second subscription to perform power-monitoring operations during the upcoming compressed-mode gap of the first subscription in response to determining that the start time of the second paging-reception period is later than the start time of the upcoming compressed-mode gap of the first subscription.

In some embodiments, the embodiment methods may include scheduling the second subscription to perform power-monitoring operations near in time to the first paging-reception period in response to determining that the start time of the second paging-reception period is not later than the start time of the upcoming compressed-mode gap of the first subscription.

In some embodiments, identifying an upcoming compressed-mode gap of the first subscription may include receiving compressed-mode information for the first subscription from a network of the first subscription and identifying the upcoming compressed-mode gap of the first subscription based on the received compressed-mode information.

In some embodiments, the embodiment methods may include determining whether updated compressed-mode information for the first subscription is available from the network of the first subscription and receiving the updated compressed-mode information from the network in response to determining that the updated compressed-mode information for the first subscription is available from the network of the first subscription.

In some embodiments, the embodiment methods may include receiving compressed-mode information for the first subscription from a network of the first subscription, initializing a list of compressed-mode-gap events, identifying an upcoming compressed-mode gap based on the received compressed-mode information, determining scheduling information for the identified upcoming compressed-mode gap, and generating a compressed-mode-gap event and adding the generated compressed-mode-gap event to the list, based on the determined scheduling information for the identified upcoming compressed-mode gap.

In some embodiments, the embodiment methods may include determining whether the compressed-mode-gap event in the list has occurred and removing the compressed-mode-gap event from the list in response to determining that the compressed-mode-gap event has occurred.

In some embodiments, determining whether the compressed-mode-gap event in the list has occurred may include waiting a predetermined period of time and determining whether the compressed-mode-gap event in the list has occurred in response to waiting the predetermined period of time.

In some embodiments, identifying an upcoming compressed-mode gap of the first subscription may include determining a start time associated with a compressed-mode-gap event that is ordered first in the list, and scheduling the second subscription to perform power-monitoring operations during the identified upcoming compressed-mode gap of the first subscription may include identifying a second paging-reception period of the second subscription that is schedule to occur after a first paging-reception period of the second subscription in response to determining that the first paging-reception period is about to start, determining a start time of the second paging-reception period, determining whether the start time of the second paging-reception period is later than the start time associated with the compressed-mode-gap event ordered first in the list, and scheduling the second subscription to perform power-monitoring operations during a compressed-mode gap associated with the compressed-mode-gap event that is ordered first in the list in response to determining that the start time of the second paging-reception period is later than the start time associated with the compressed-mode-gap event ordered first in the list.

In some embodiments, the embodiment methods may include scheduling the second subscription to perform power-monitoring operations near in time to the first paging-reception period in response to determining that the start time of the second paging-reception period is not later than the start time associated with the compressed-mode-gap event ordered first in the list.

Various embodiments may include a mobile communication device configured with processor-executable instructions to perform operations of the methods described above.

Various embodiments may include a mobile communication device having means for performing functions of the operations of the methods described above.

Various embodiments may include non-transitory processor-readable media on which are stored processor-executable instructions configured to cause a processor of a mobile communication device to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of mobile telephony networks suitable for use with various embodiments.

FIG. 2 is a component block diagram of a multi-SIM communication device according to various embodiments.

FIG. 3 is a component block diagram illustrating the interaction between components of different transmit/receive chains in a multi-SIM communication device according to various embodiments.

FIGS. 4A-4B are timeline diagrams illustrating a first subscription's performing transmit (Tx) blanking during a second subscription's paging-reception and power-monitoring operations on a conventional mobile communication device.

FIG. 5 is a timeline diagram illustrating scheduling a second subscription to perform power-monitoring operations during compressed-mode gaps in a first subscription's transmissions according to various embodiments.

FIG. 6 is a process flow diagram illustrating a method for scheduling a second subscription to perform power-monitoring operations during compressed-mode gaps in the first subscription's transmissions according to various embodiments.

FIG. 7 is a component block diagram illustrating data structures that may be useful in scheduling a second subscription to perform power-monitoring operations during compressed-mode gaps in the first subscription's transmissions according to various embodiments.

FIG. 8 is a process flow diagram illustrating a method for populating a time-ordered list with compressed-mode-gap events associated with upcoming compressed-mode gaps in the first subscription transmissions according to various embodiments.

FIG. 9 is a process flow diagram illustrating a method for scheduling a second subscription to perform power-monitoring operations during compressed-mode gaps in the first subscription's transmissions based on start times of the compressed-mode gaps according to various embodiments.

FIG. 10 is a process flow diagram illustrating a method for updating an ordered list of compressed-mode-gap events in response to determining that a compressed-mode event in the list has occurred according to various embodiments.

FIG. 11 is a component block diagram of a mobile communication device suitable for implementing some embodiment methods.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “SIM”, “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the terms “SIM” and “subscription” are used interchangeably and are used herein as a shorthand reference to refer to the communication service associated with and enabled by the information stored in a particular SIM as the SIM and the communication network, as well as the services and subscriptions supported by that network, correlate to one another.

As used herein, the terms “mobile communication device” and “multi-SIM communication device” are used interchangeably and refer to any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices that include a programmable processor, memory, and circuitry for connecting to at least two mobile communication networks. The various aspects may be useful in mobile communication devices, such as smart phones, and so such devices are referred to in the descriptions of various embodiments. However, the embodiments may be useful in any electronic devices, such as a dual-SIM-dual-active communication device, that may individually maintain a plurality of subscriptions that utilize a plurality of separate RF resources.

Transmissions associated with one or more subscriptions on a multi-SIM communication device may negatively affect the performance of other subscriptions operating on the multi-SIM communication device. For example, a DSDA communication device may suffer from intra-device interference when an aggressor subscription is transmitting while a victim subscription in the DSDA communication device is simultaneously attempting to receive transmissions. During such a “coexistence event,” the aggressor subscription's transmissions may cause severe impairment to the victim's ability to receive transmissions. This interference may be in the form of blocking interference, harmonics, intermodulation, and other noises and distortion received by the victim. Such interference may significantly degrade the victim's receiver sensitivity, voice call quality and data throughput. These effects may also result in a reduced network capacity of the multi-SIM communication device.

In many conventional solutions implemented on multi-SIM communication devices for mitigating victim de-sense, a multi-SIM communication device configures the aggressor subscription to reduce or zero its transmit power while the victim subscription is receiving transmissions. This is referred to as transmit (“Tx”) blanking Implementing Tx blanking according to conventional solutions increases the error probability of subsequently received information from the network and decreases the aggressor's overall throughput. Further, these current solutions incur a cost on the link-level performance of the aggressor subscription/technology being blanked and/or impact the aggressor's reverse-link throughput. Thus, while current solutions for utilizing Tx blanking are effective at reducing the victim subscription's de-sense, the improvement to the victim's reception performance is often at the expense of the aggressor subscription's performance.

A victim subscription performs both power monitoring and paging reception while operating in an idle-standby mode (e.g., while the victim subscription is not on an active voice or data call). In conventional multi-SIM-multi-active communication devices, the aggressor subscription currently performs Tx blanking while the victim performs both power monitoring activities and paging reception activities. As a resulting of implementing Tx blanking throughout the victim subscription's idle-standby-mode operations, the aggressor subscription experiences a substantial decrease in its overall throughput and performance.

Typically, a victim subscription's paging-reception operations are scheduled by the victim's network and cannot be rescheduled by the multi-SIM communication device, and the aggressor subscription may be unable to avoid performing Tx blanking during the victim subscription's page reception activities. However, the victim's power-monitoring operations are scheduled by the device, not by a network, and therefore may be scheduled locally on the device.

Recently, some solutions have been implemented on dual-SIM-dual-standby (DSDS) communication devices to reduce the impact of tuning away from a first subscription (i.e., an active subscription) to a second subscription (i.e., an idle subscription) to enable the second subscription to perform idle-standby-mode operations by scheduling the second subscription's power-monitoring operations to occur during periods that differ from when such measurements are conventionally scheduled. Specifically, such solutions relate to decoupling when the second subscription performs page reception and power measurements of neighboring cells and scheduling the second subscription's power measurements to coincide with an idle frame or frames during which the first subscription is not transmitting or receiving. However, these solutions are designed for use on mobile communication devices in which the first and second subscription share the same RF resource, thereby requiring the first subscription to lose access to the shared RF chain during the idle frame(s) to facilitate the second subscription's power measurements.

To overcome the disadvantages of known methods for mitigating de-sense in multi-SIM-multi-active communication devices, various embodiments enable each subscription to access its own RF chain and communicate with its network simultaneously. In particular, the victim subscription's power-monitoring operations are scheduled to occur during transmission gaps that occur while the aggressor subscription is operating in a compressed mode.

In overview, various embodiments provide methods implemented by a processor executing on a mobile communication device (e.g., a multi-SIM-multi-active communication device) to opportunistically schedule a victim subscription's power-monitoring activities to occur during periods in which the aggressor subscription is already scheduled not to transmit, thereby reducing the amount of time the aggressor subscription must perform Tx blanking to accommodate the victim subscription's idle-standby-mode operations. As a result, the overall throughput/performance of an aggressor subscription is improved as the aggressor experiences relatively fewer blanked transmissions without affecting the victim subscription's ability to perform power-monitoring operations.

In some embodiments, the device processor may schedule the victim subscription to perform power-monitoring operations without respect to the victim's other idle-standby-mode operations. In other words, the device processor may decouple when the victim subscription performs power monitoring and paging reception operations by opportunistically scheduling the victim subscription's power-monitoring operations to occur during times in which the aggressor subscription is not scheduled to transmit. Specifically, the device processor may identify periods of transmission inactivity of an aggressor while the aggressor subscription is operating in a compressed mode (sometimes referred to as “compressed-mode gaps”). In response to identifying an upcoming compressed-mode gap, the device processor may schedule the power-monitoring operations of the victim subscription to occur during the identified compressed-mode gap. Because the aggressor subscription is already scheduled not to transmit during these periods of inactivity, the victim subscription may perform power monitoring during this time without requiring the aggressor to perform Tx blanking, thereby enabling the victim subscription to avoid de-sense while maintaining the aggressor subscription's overall throughput and performance quality.

In some embodiments, the device processor may schedule the victim subscription's power-monitoring operations based on a start time of an upcoming compressed-mode gap and a start time of a second paging-reception period scheduled to occur after a first paging-reception period that is about to start. In other words, the device processor may determine whether the upcoming compressed-mode gap will occur before the victim subscription's second paging-reception period is scheduled to occur. In such embodiments, in response to determining that the start time of the second paging-reception period is later than the start time of the upcoming compressed-mode gap, the device processor may opportunistically schedule the second subscription to perform power-monitoring operations during the upcoming compressed-mode gap. In response to determining that the start time of the second paging-reception period is not later than the start time of the upcoming compressed-mode gap, the device processor may schedule the second subscription to perform power-monitoring operations near in time to the second subscription's first paging-reception period.

In some embodiments, the device processor may utilize one or more data structures for scheduling the victim subscription's power-monitoring operations during the aggressor subscription's compressed-mode gaps. For example, the device processor may initialize an ordered list and populate the list with one or more compressed-mode-gap events generated from one or more upcoming compressed-mode gaps related to the aggressor subscription. In such embodiments, the device processor may utilize the list to determine the compressed-mode gap that will occur next (e.g., the compressed-mode-gap event ordered first in the list).

In some embodiments, the device processor may continually update the list of compressed-mode-gap events by removing events from the list that have already occurred. For example, in response to determining that the compressed-mode-gap event ordered first in the list has occurred, the device processor may remove that event from the list, thereby keeping the list up to date.

Subscriptions' activities may change during the ordinary course of operating on a multi-SIM-multi-active communication device, such as when a subscription ceases a transmission cycle and begins a reception cycle or when a subscription switches from an active mode to an idle-standby mode (or vice versa). In such instances, an aggressor subscription at a first time may become a victim subscription at a second time, and the victim subscription at the first time may similarly become an aggressor subscription at a second or third time. Thus, while various embodiments are described with reference to an aggressor subscription and a victim subscription, the subscriptions may be referred to generally as a first subscription and a second subscription to reflect that the subscriptions' roles as an aggressor or a victim may change.

In various embodiments, the first subscription (i.e., an aggressor subscription) may utilize a first radio access technology or “RAT” to communicate with its mobile network, and the second subscription (i.e., the victim subscription) may receive communications from its mobile network via a second RAT that differs from the first RAT. Such embodiments may be especially useful on mobile communication devices in which the first subscription utilizes a WCDMA or LTE RAT or an Orthogonal Frequency-Division Multiple Access (OFDMA) while the second subscription uses a GSM RAT, and thus, these configurations may be referenced in the various descriptions. However, various embodiments may be useful generally on any mobile communication device in which the first subscription utilizes a RAT that supports compressed mode operations.

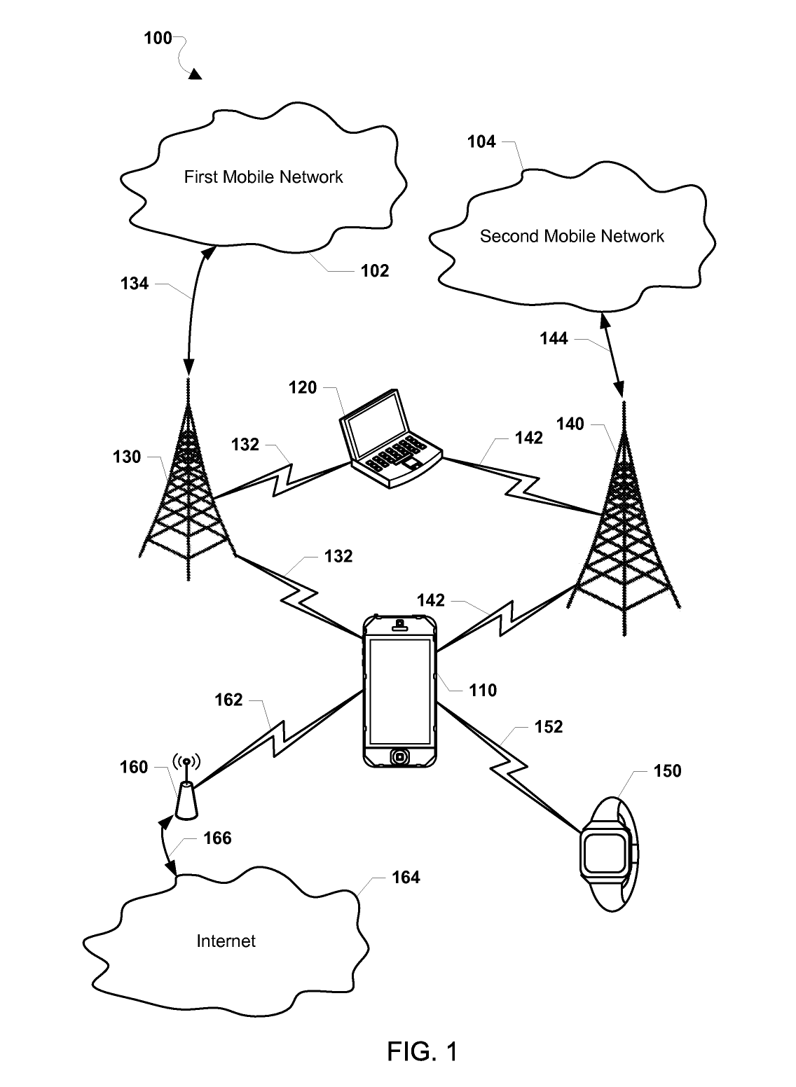

Various embodiments may be implemented within a variety of communication systems 100 that include at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may communicate with the second mobile network 104 through the cellular connection 142 to the second base station 140. The cellular connections 132 and 142 may be made through two-way wireless communication links, such as 4G, 3G, CDMA, TDMA, WCDMA, GSM, LTE, and other mobile telephony communication technologies.

While the mobile communication devices 110, 120 are shown connected to the mobile networks 102, 104, in some embodiments (not shown), the mobile communication devices 110, 120 may include two or more subscriptions to two or more mobile networks 102, 104 and may connect to those subscriptions in a manner similar to those described above.

In some embodiments, the first mobile communication device 110 may establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some embodiments, the first mobile communication device 110 may establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

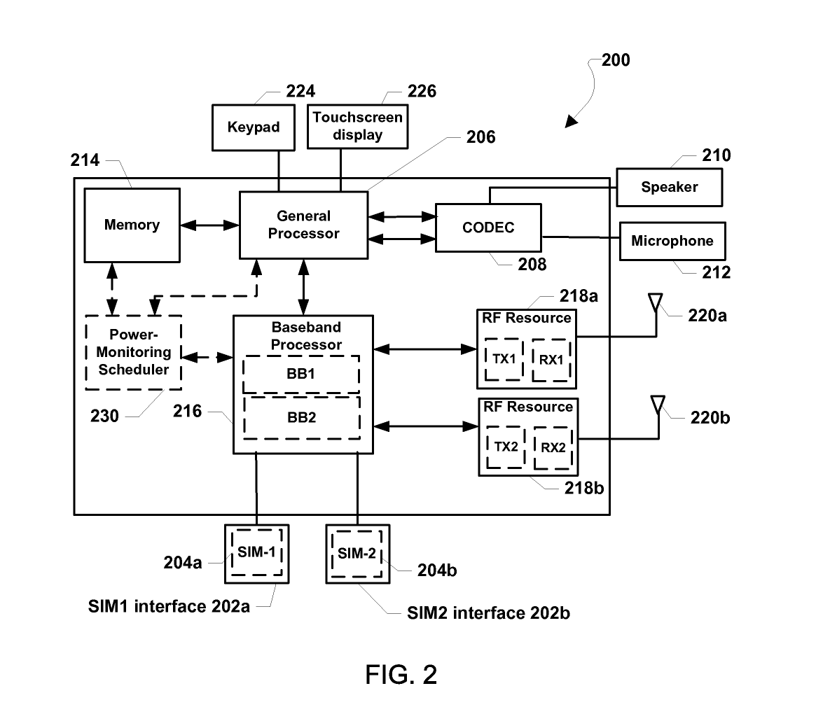

FIG. 2 is a functional block diagram of a mobile communication device 200 suitable for implementing various embodiments. According to various embodiments, the mobile communication device 200 may be similar to one or more of the mobile communication devices 110, 120 as described with reference to FIG. 1. With reference to FIGS. 1-2, the mobile communication device 200 may include a first SIM interface 202a, which may receive a first identity module SIM-1 204a that is associated with a first subscription. The mobile communication device 200 may also include a second SIM interface 202b, which may receive a second identity module SIM-2 204b that is associated with a second subscription.

A SIM in various embodiments may be a Universal Integrated Circuit Card (UICC) that is configured with SIM and/or USIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the mobile communication device 200 (e.g., memory 214), and thus need not be a separate or removable circuit, chip or card.

The mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure.

The general processor 206 and the memory 214 may each be coupled to at least one baseband modem processor 216. Each SIM in the mobile communication device 200 (e.g., the SIM-1 204a and the SIM-2 204b) may be associated with a baseband-RF resource chain. A baseband-RF resource chain may include the baseband modem processor 216, which may perform baseband/modem functions for communicating with/controlling a RAT, and may include one or more amplifiers and radios, referred to generally herein as RF resources 218a, 218b. In some embodiments, baseband-RF resource chains may share the baseband modem processor 216 (i.e., a single device that performs baseband/modem functions for all SIMs on the mobile communication device 200). In other embodiments, each baseband-RF resource chain may include physically or logically separate baseband processors (e.g., BB1, BB2).

In some embodiments, the RF resources 218a, 218b may be associated with different subscriptions and/or RATs. For example, a first subscription utilizing a first RAT (e.g., a WCDMA or LTE RAT) may be associated with the RF resource 218a, and a second subscription utilizing a second RAT (e.g., a GSM RAT) may be associated with the RF resource 218b. The RF resources 218a, 218b may each be transceivers that perform transmit/receive functions on behalf of their respective subscriptions/RATs. The RF resources 218a, 218b may also include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

In some embodiments, the general processor 206, the memory 214, the baseband processor(s) 216, and the RF resources 218a, 218b may be included in the mobile communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the mobile communication device 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the mobile communication device 200 to enable communication between them, as is known in the art.

Functioning together, the two SIMs 204a, 204b, the baseband modem processor 216, the RF resources 218a, 218b, and the wireless antennas 220a, 220b may constitute two or more RATs. For example, a SIM, baseband processor, and RF resource may be configured to support two different radio access technologies, such as GSM and WCDMA. More RATs may be supported on the mobile communication device 200 by adding more SIM cards, SIM interfaces, RF resources, and/or antennae for connecting to additional mobile networks.

The mobile communication device 200 may include a power-monitoring scheduler unit 230 configured to manage and/or schedule a victim subscription's utilization of the RF resources 218a, 218b for performing power-monitoring operations. In some embodiments, the power-monitoring scheduler unit 230 may be implemented within the general processor 206. In some embodiments, the power-monitoring scheduler unit 230 may be implemented as a separate hardware component (i.e., separate from the general processor 206). In some embodiments, the power-monitoring scheduler unit 230 may be implemented as a software application stored within the memory 214 and executed by the general processor 206. In some embodiments, the power-monitoring scheduler unit 230 may identify an upcoming compressed-mode gap for a first subscription and may schedule a second subscription to perform power-monitoring operations during the upcoming compressed-mode gap.

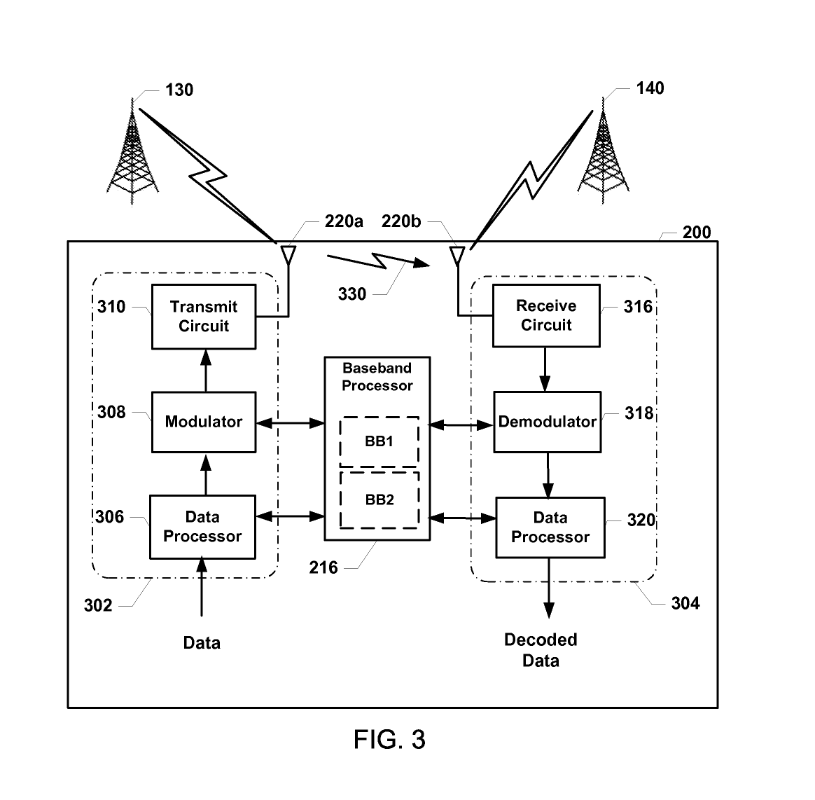

FIG. 3 is a block diagram of transmit and receive components in separate RF resources on the mobile communication device 200 described with reference to FIGS. 1-2, according to various embodiments. With reference to FIGS. 1-3, for example, a transmitter 302 may be part of the RF resource 218a, and a receiver 304 may be part of the RF resource 218b. In some embodiments, the transmitter 302 may include a data processor 306 that may format, encode, and interleave data to be transmitted. The transmitter 302 may include a modulator 308 that modulates a carrier signal with encoded data, such as by performing Gaussian minimum shift keying (GMSK). One or more transmit circuits 310 may condition the modulated signal (e.g., by filtering, amplifying, and upconverting) to generate an RF modulated signal for transmission. The RF modulated signal may be transmitted, for example, to the first base station 130 via the first wireless antenna 220a.

At the receiver 304, the second wireless antenna 220b may receive RF modulated signals from the second base station 140. However, the second wireless antenna 220b may also receive some RF signaling 330 from the transmitter 302, which may ultimately compete with the desired signal received from the second base station 140. One or more receive circuits 316 may condition (e.g., filter, amplify, and downconvert) the received RF modulated signal, digitize the conditioned signal, and provide samples to a demodulator 318. The demodulator 318 may extract the original information-bearing signal from the modulated carrier wave, and may provide the demodulated signal to a data processor 320. The data processor 320 may de-interleave and decode the signal to obtain the original, decoded data, and may provide decoded data to other components in the mobile communication device 200. Operations of the transmitter 302 and the receiver 304 may be controlled by a processor, such as the baseband modem processor 216. In various embodiments, each of the transmitter 302 and the receiver 304 may be implemented as circuitry that may be separated from their corresponding receive and transmit circuitries (not shown). Alternatively, the transmitter 302 and the receiver 304 may be respectively combined with corresponding receive circuitry and transmit circuitry, for example, as transceivers associated with the SIM-1 204a and the SIM-2 204b.

Receiver de-sense may occur when transmissions of a first subscription on the uplink (e.g., the RF signaling 330) interferes with receive activity on a different transmit/receive chain associated with a second subscription. The signals received by the second subscription may become corrupted and difficult or impossible to decode as a result of the de-sense or interference. Further, noise from the transmitter 302 may be detected by a power monitor (not shown) that measures the signal strength of surrounding cells, which may cause the mobile communication device 200 to falsely determine the presence of a nearby cell site.

As described, conventional mobile communication devices attempt to mitigate the effects of de-sense on a victim subscription by configuring the aggressor subscription to blank or reduce the power of its transmissions during times in which the victim subscription is attempting to perform reception activities (e.g., paging-reception and power-monitoring operations).

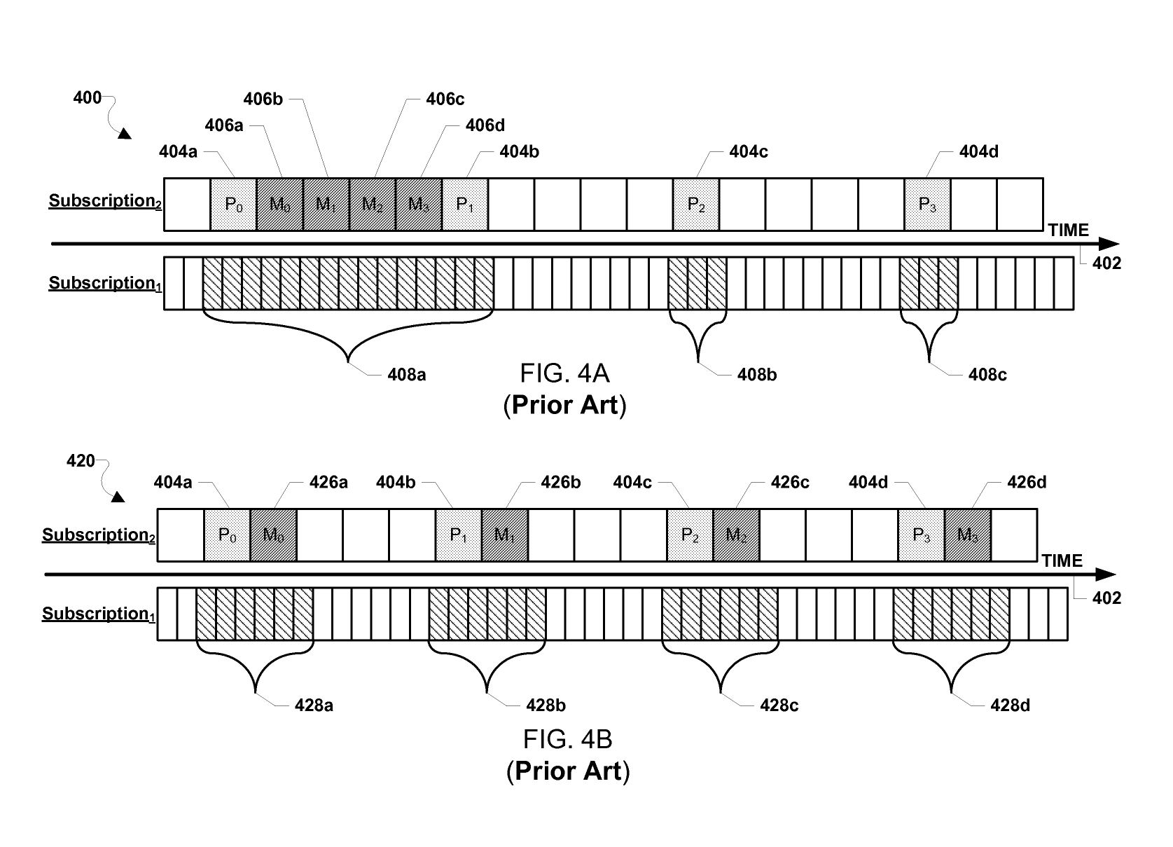

FIGS. 4A-4B illustrate example timeline diagrams 400, 420 that show conventional strategies for enabling a second subscription (i.e., a victim subscription) to perform idle-standby-mode operations while a first subscription (i.e., an aggressor subscription) is transmitting as currently implemented on mobile communication devices. Specifically, the timeline diagrams 400, 420 illustrate the effects on the transmission throughput of the first subscription as a result of performing Tx blanking during the second subscription's paging-reception and power-monitoring operations.

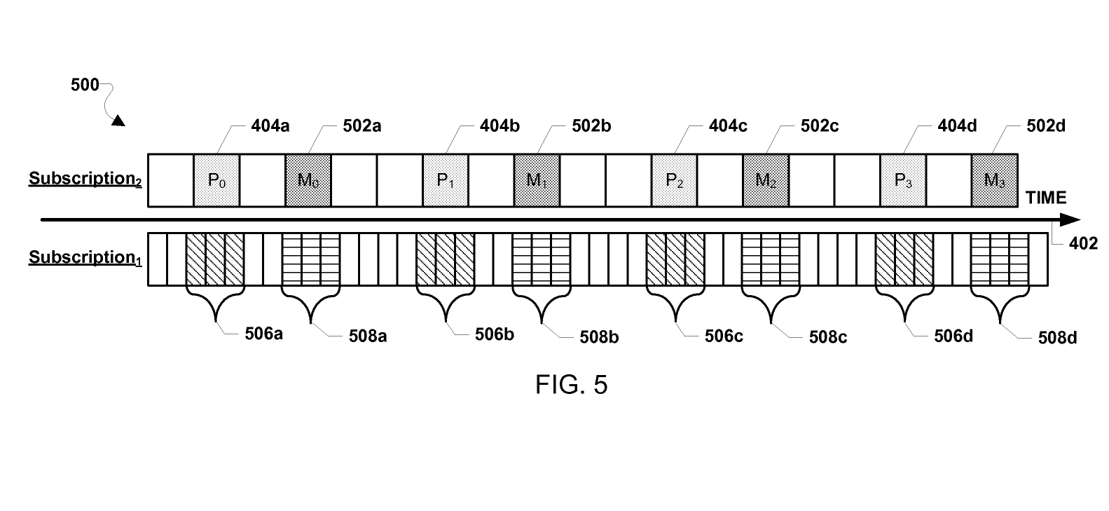

Referring to FIG. 4A, the timeline diagram 400 illustrates a pattern of idle-standby-mode operations performed by the second subscription (labeled in FIG. 4A as “Subscription”) over time 402. While operating in an idle-standby mode, the second subscription periodically receives paging messages from its mobile network that enables the second subscription to maintain a connection with the mobile network. For example, the paging messages may indicate whether a voice call for the second subscription is pending. As described, the second subscription's mobile network may schedule the transmission (or retransmission) of these paging messages during predetermined times, such as during paging-reception periods 404a-404d (labeled in FIGS. 4A-5 as P₀-P₃).

In addition to performing paging reception activities, the second subscription also occasionally performs power-monitoring operations, for example, to detect and measure the transmit power of neighboring cells. Based on these power-monitoring operations, the second subscription may initiate a cell reselection to acquire service with a neighboring cell that may offer better service than the second subscription's current cell. Further, in contrast to paging-reception operations that are scheduled by the second subscription's mobile network, a device processor on the mobile communication device may schedule the second subscription to perform power-monitoring operations.

In a common implementation, the device processor schedules the second subscription to perform all power-monitoring operations following a paging-reception period. Thus, as illustrated in the timeline diagram 400, immediately after performing paging reception during the paging-reception period 404a, the second subscription performs power-monitoring operations during power monitoring periods 406a-406d (labeled in FIG. 4A as “M₀”-“M₃”).

In order to ensure that the second subscription is not de-sensed during its idle-standby-mode operations, the first subscription (labeled in FIGS. 4A-5 as “Subscription₁”) performs Tx blanking (or reduces its transmit power) during blanking periods 408a-408c that correspond with the paging-reception periods 404a-404d and with the power monitoring periods 406a-406d. In the conventional implementation described above, because the power monitoring periods 406a-406d are scheduled to occur immediately after the paging-reception period 404a, the blanking period 408a may last for a relatively long time (e.g., in comparison to the blanking periods 408b-408c), causing the first subscription to experience a drop in throughput and performance as its transmission power is zeroed (or reduced) for the entire blanking period 408a.

Referring to FIG. 4B, the timeline diagram 420 illustrates another implementation of Tx blanking on a conventional mobile communication device. In such an implementation, the device processor schedules the power-monitoring operations of the second subscription to reduce the overall impact of Tx blanking on the first subscription. Specifically, the device processor may spread or stagger when the second subscription performs power-monitoring operations to reduce the maximum amount of time the first subscription must perform Tx blanking during a given period.

In the example timeline diagram 420, the second subscription's network schedules the second subscription to perform paging reception operations during paging-reception periods 404a-404d as described (e.g., see FIG. 4A). While the device processor may not reschedule the paging-reception periods 404a-404d, the device processor may schedule the power monitoring periods 426a-426d (labeled in FIG. 4B as “M₀”-“M₃”) such that the power monitoring periods 426a-426d are spaced out. Specifically, in the illustrated example, the device processor schedules only one of the power monitoring periods 426a-426d to occur after each of the paging-reception periods 404a-404d. Based on the scheduled power monitoring periods 426a-426d and paging-reception periods 404a-404d, the device processor configures the first subscription to perform Tx blanking during blanking periods 428a-428d. Because the power monitoring periods 426a-426d are spread out, the first subscription may avoid the comparatively long blanking periods as described with reference to other conventional implementations (e.g., the blanking period 408a in the timeline diagram 400).

While some conventional strategies for scheduling power-monitoring operations for a second subscription attempt to lessen the effects of Tx blanking on a first subscription, these conventional implementations still require the first subscription to perform Tx blanking during the second subscription's power-monitoring operations (i.e., during power monitoring periods 426a-426d), resulting in an reduced throughput and performance. In contrast, various embodiments enable the device processor to opportunistically schedule the power-monitoring operations of a second subscription to occur during prearranged gaps in the first subscription's transmissions corresponding to when the first subscription is operating in a compressed mode.

FIG. 5 illustrates a timeline diagram 500 related to scheduling power-monitoring operations of a second subscription to occur during compressed-mode gaps of the first subscription to reduce the overall amount of time the first subscription is required to perform Tx blanking according to various embodiments.

With reference to FIGS. 1-5, the second subscription's network may independently schedule the paging-reception periods 404a-404d as described (e.g., see FIGS. 4A-4B), and the first subscription may implement Tx blanking during blanking periods 506a-506d that correspond with those paging-reception periods 404a-404d. In other words, because the second subscription's network schedules the paging-reception periods and the device processor may not change that schedule, the first subscription may not be able to avoid performing Tx blanking during the blanking periods 506a-506d.

As part of normal/typical operations, the device processor may receive information from the first subscription's network regarding periods of time (i.e., compressed-mode gaps) in which the first subscription may cease transmitting while operating in a compressed mode in order to perform, among other things, power measurements, etc. As shown in the illustrated example, the device processor may identify compressed-mode gaps 508a-508d based on the scheduling information received from the first subscription's network, and the first subscription may cease transmitting during these gaps 508a-508d.

In response to identifying the compressed-mode gaps 508a-508d, the device processor may opportunistically schedule the second subscription to perform power-monitoring operations during these gaps 508a-508d. Because the first subscription is already scheduled not to transmit during the compressed-mode gaps 508a-508d, the second subscription may take accurate power measurements during the power monitoring periods 502a-502d (labeled in FIG. 5 as “M₀”-“M₃”). By scheduling the second subscription's power measurements to occur during the compressed-mode gaps 508a-508d, the device processor may enable the second subscription to avoid de-sense without affecting the first subscription's transmissions. In other words, the device processor may accommodate the second subscription's power monitoring activities without needing to configure the first subscription to blank/reduce its transmissions at times in which the first subscription may be scheduled to transmit.

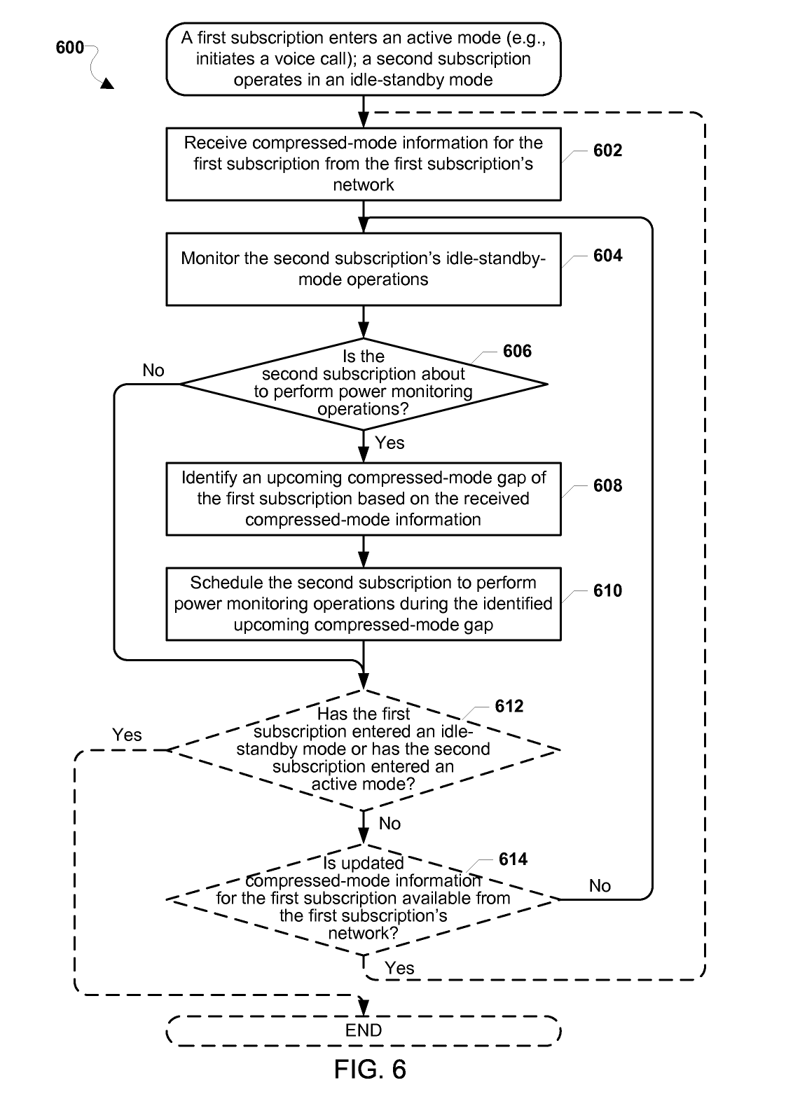

FIG. 6 illustrates a method 600 that may be implemented by a processor (e.g., the general purpose processor 206 of FIG. 2, the baseband modem processor 216, the power-monitoring scheduler unit 230, a separate controller, and/or the like) executing on a mobile communication device (e.g., the mobile communication device 200 of FIG. 2) for scheduling a victim subscription (i.e., a second subscription) to perform power-monitoring operations during an identified compressed-mode gap of an aggressor subscription (i.e., a first subscription). With reference to FIGS. 1-6, the device processor may begin performing the operations of the method 600 in response to the first subscription's entering an active mode and the second subscription's operating in an idle-standby mode, which may indicate a risk that the second subscription may be de-sensed by the first subscription. In other words, the device processor may begin performing the operations of the method 600 in response to determining that a coexistence event may occur (or may be occurring) between the first subscription and the second subscription.

In some embodiments, the first subscription may enter an active mode in response to initiating an active call, such as a voice or data call. While operating in an active mode, the first subscription may frequently transmit voice or data information to its network via an uplink connection. For example, the first subscription may utilize a first RF resource (e.g., the RF resource 218a of FIG. 2) to transmit voice information to its network (i.e., a WCDMA mobile network or an LTE mobile network). While the first subscription is operating in active mode, the second subscription may be operating in an idle-standby mode. Specifically, while the second subscription may not be engaged in an active call, the second subscription may still periodically need to receive signals from its network (i.e., paging reception) and from neighboring cells (i.e., power-monitoring operations to facilitate cell reselection). In some embodiments, the second subscription may receive signals from its network (i.e., a GSM mobile network) (e.g., the RF resource 218b of FIG. 2) and from neighboring cells via a second RF resource while the first subscription is operating in an active mode.

In block 602, the device processor may receive compressed-mode information for the first subscription from the first subscription's network. As described, such network information may include timing or scheduling information that may enable the device processor to determine or identify times at which the first subscription is scheduled to perform in a compressed mode, for example, to take power measurements.

In block 604, the device processor may monitor the second subscription's idle-standby-mode operations, such as by referencing a predetermined schedule of idle-standby-mode operations stored in memory (i.e., the memory 214 of FIG. 2) that the second subscription is expected to perform. In some embodiments of the operations performed in block 604 in which the second subscription's power-monitoring operations are scheduled in relation to the second subscription's paging reception operations (see FIGS. 4A-4B), the device processor may determine a discontinuous reception (DRX) cycle for the second subscription and may monitor for the next time the second subscription is scheduled to perform power-monitoring operations based on the second subscription's DRX cycle and/or based on the next time the second subscription is scheduled to perform paging-reception operations.

In determination block 606, the device processor may determine whether the second subscription is about to perform power-monitoring operations. In response to determining that the second subscription is about to perform power-monitoring operations (i.e., determination block 606=“Yes”), the device processor may identify an upcoming compressed mode gap of the first subscription in block 608 based on the compressed mode information received in block 602. In some embodiments, the scheduling information received from the first subscription's network may describe and/or indicate a start time for the next compressed mode gap based. For example, based on a current time observed on the mobile communication device, the device processor may determine from the received information that the first subscription's next compressed mode gap will occur within a certain period of time in the future.

In response to identifying an upcoming compressed mode gap in block 608, the device processor may schedule the second subscription to perform power-monitoring operations during the identified upcoming compressed mode gap in block 610. As described, during the identified upcoming compressed mode gap, the first subscription may already be scheduled to suspend its transmissions in order to perform various operations (e.g., power monitoring), thereby enabling the second subscription to perform power-monitoring operations without the risk of being de-sensed by the first subscription and without requiring the first subscription to perform Tx blanking during the second subscription's power-monitoring operations. As a result, the second subscription may take accurate power measurements, and the first subscription may experience a relatively higher throughput and quality of performance than conventional implementations (e.g., as described with reference to FIGS. 4A-4B).

In response to determining that the second subscription is not about to perform power-monitoring operations (i.e., determination block 606=“No”) or in response to scheduling the second subscription to perform power-monitoring operations during the identified upcoming compressed-mode gap in block 610, the device processor may optionally determine whether the first subscription has entered an idle-standby mode or whether the second subscription has entered an active mode in optional determination block 612. In other words, the device processor may determine whether there is a continued risk that the first subscription will de-sense the second subscription's idle-standby-mode operations and, thus, that there is a continued need to perform the above operations to reduce the impact of Tx blanking on the first subscription. In response to determining that the first subscription has entered an idle standby mode or that the second subscription has entered an active mode (i.e., optional determination block 612=“Yes”), the device processor may cease performing operations of the method 600.

In response to determining that the first subscription has not entered an idle standby mode and that the second subscription has not entered an active mode (i.e., optional determination block 612=“No”), the device processor may optionally determine whether updated compressed-mode information for the first subscription is available from the first subscription's network in optional determination block 614. In some embodiments, the first subscription's network may periodically transmit updated compressed-mode information regarding additional, upcoming compressed-mode gaps for the first subscription. For example, the updated compressed-mode information may include scheduling information for one or more scheduled compressed-mode gaps that occur after the compressed-mode gaps indicated in a previous version of the compressed-mode information.

In response to determining that updated compressed-mode information for the first subscription is available from the first subscription's network (i.e., optional determination block 614=“Yes”), the device processor may repeat the above operations in block 602 of the method 600 by receiving updated compressed-mode information for the first subscription from the first subscription's network. In response to determining that updated compressed-mode information for the first subscription is not available (or not yet available) from the first subscription's network (i.e., optional determination block 614=“No”), the device processor may again monitor the second subscription's idle standby mode operations using previously received compressed-mode information in block 604 and repeat the operations of the method 600.

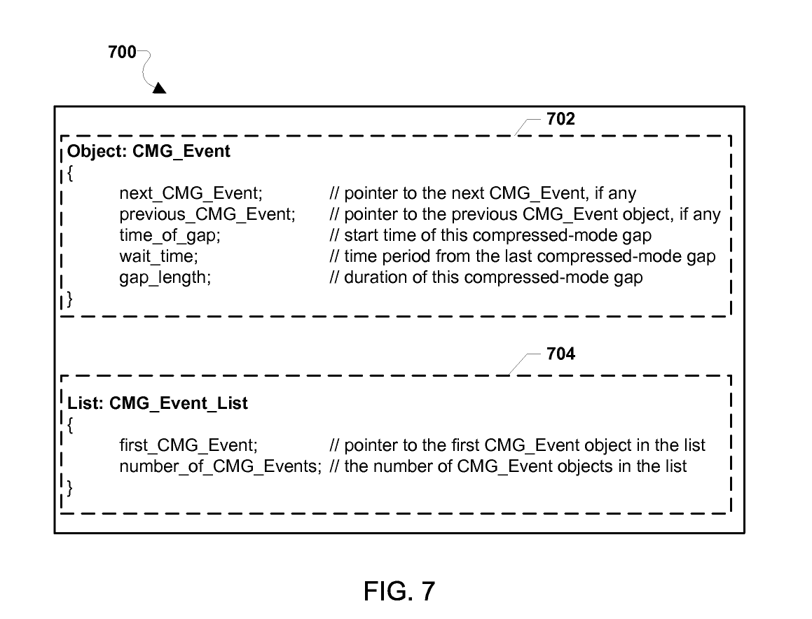

FIG. 7 illustrates a component block diagram 700 of data structures 702, 704 that may be suitable for use by a device processor (e.g., the general purpose processor 206 of FIG. 2, the baseband modem processor 216, the power-monitoring scheduler unit 230, a separate controller, and/or the like) on a mobile communication device (e.g., the mobile communication device 200 of FIG. 2) for implementing various embodiments.

With reference to FIGS. 1-7, the device processor may identify compressed-mode gaps for a first subscription from information received from a network of the first subscription, in various embodiments. In order to effectively schedule the power-monitoring operations of a second subscription based on these identified compressed-mode gaps, the device processor may generate at least one compressed-mode-gap event object (labeled in FIG. 7 as an “CMG_Event” object) according to the CMG_Event object data structure 702, and each CMG_Event object may include/be associated with information relevant to scheduling the second subscription's power-monitoring operations during one or more of the first subscription's compressed-mode gaps.

In some embodiments, the device processor may generate and maintain an ordered list of CMG_Event objects based on a list data structure 704 (i.e., labeled as a “CMG_Event_List” list in FIG. 7) that correspond to the first subscription's upcoming compressed-mode gaps. In such embodiments, each CMG_Event object in the list may correspond with a particular upcoming compressed-mode gap.

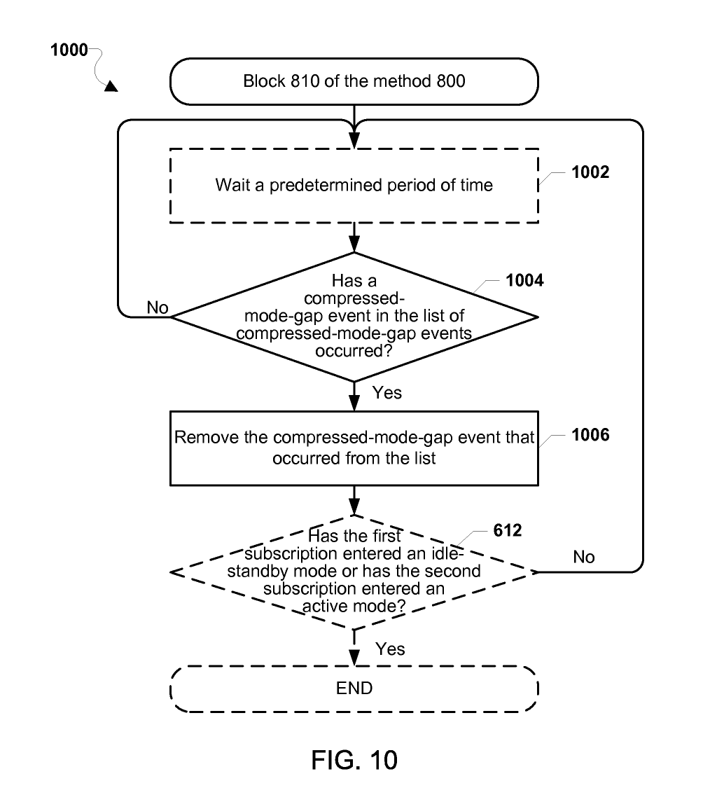

In some embodiments, the list of CMG_Event objects may include a reference or pointer to the first_CMG_Event object in the list (labeled in the data structure 704 as “first_CMG_Event”). In such embodiments, the first CMG_Event object may correspond with a compressed-mode gap that is scheduled to occurred next (i.e., is closest in time to occurring based on the current time observed on the mobile communication device). Thus, by keeping track of the first CMG_Event object in the ordered list, the device processor may quickly retrieve information that is relevant to the compressed-mode gap for the first subscription that is expected to occur next. In some embodiments (e.g., see FIG. 10), the device processor may periodically update the list of CMG_Event objects by removing the first CMG_Event object from the list based on the current observed time. For example, the device processor may remove a first CMG_event object in response to determining that the compressed-mode gap associated with that object has already occurred. As a result, the device processor may update the first_CMG_Event reference/pointer in the list to point to a second CMG_Event (i.e., the new first CMG_Event that is expected to occur next based on the current time).

The device processor may associate certain information with each CMG_Event object as illustrated in the CMG_Event object data structure 702. Specifically, for each CMG_Event object, the device processor may maintain several pointer/references to other CMG_objects for use in maintaining the list of CMG_Event objects. For example, a CMG_Event object may include a reference/pointer to a CMG_Event object in the list that will occur earlier in time, if any, (illustrated in the data structure 702 as “previous_CMG_Event”) and a reference/pointer to a CMG_Event object in the list that will occur later in time, if any (in the data structure 702 as “next_CMG_Event”). The device processor may traverse the list of CMG_Event objects based on these references, for example, by following a reference to a next or previous CMG_Event object.

A CMG_Event object may also be associated with a start time of a compression-mode gap (labeled in the data structure 702 as “time_of_gap”). In some embodiments, the device processor may determine the start time of the compression-mode gap based on information received from the first subscription's network and may add the CMG_Event object to the list of CMG_Event objects based on its start time, thereby ensuring the list is ordered with respect to the start times of the CMG_Event objects included in the list (e.g., from earliest in time to latest in time).

In some embodiments, the device processor may calculate a time period from a previous compression-mode gap to a current compression-mode gap and may associate this time period (labeled in the data structure 702 as “wait_time”) with the CMG_Event object related to the current compression-mode gap. The device processor may also determine the duration of the compressed-mode gap, such as based on the information received from the first subscription's network, and may associate that duration with the corresponding CMG_Event object (labeled in the data structure 702 as “gap_length”).

Thus, by utilizing the data structures 702, 704 to collect and organize scheduling information for one or more upcoming compressed-mode gaps of a first subscription, the device processor may quickly and effectively schedule the second subscription to perform power-monitoring operations during these compressed-mode gaps as described herein.

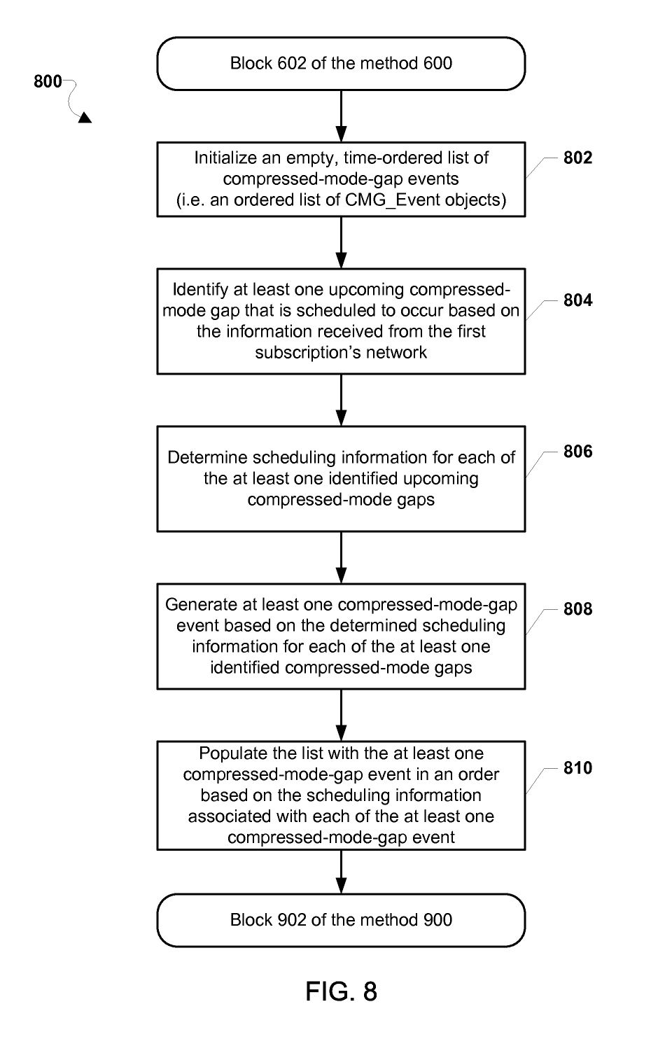

FIG. 8 illustrates a method 800 that may be implemented by a processor (e.g., the general purpose processor 206 of FIG. 2, the baseband modem processor 216, the power-monitoring scheduler unit 230, a separate controller, and/or the like) on a mobile communication device (e.g., the mobile communication device 200 of FIG. 2) for initializing a list of compressed-mode-gap events and populating the list with upcoming compressed-mode-gap events associated with a first subscription. The operations of the method 800 implement some embodiments of the operations of the method 600 (FIG. 6). Thus, with reference to FIGS. 1-8, the device processor may begin performing the operations of method 800 in response to receiving compressed-mode information for the first subscription from the first subscription's network in block 602 of the method 600.

In block 802, the device processor may initialize an empty, time-ordered list of compressed-mode-gap events. In some embodiments, the device processor may implement various data structures (e.g., the data structures 702, 704 of FIG. 7) that may be useful in tracking upcoming compressed-mode gaps of the first subscription and scheduling the second subscription's power-monitoring operations to occur during those compressed-mode gaps.

In block 804, the device processor may identify at least one upcoming compressed-mode gap of the first subscription that is scheduled to occur based on the information received from the first subscription's network in block 602 of the method 600. In other words, the device processor may analyze the first subscription's network information to determine upcoming time periods during which the first subscription will be operating in a compressed mode. In some embodiments, the network information of the first subscription may include absolute or relative timing information indicating time periods during which the first subscription will operate in the compressed mode. For example, the network information may indicate that the first subscription is scheduled to operate in a compressed mode periodically starting at a particular time.

In response to identifying the at least one upcoming compressed-mode gap in block 804, the device processor may determine scheduling information for each of the at least one identified upcoming compressed-mode gaps, in block 806. In some embodiments, the device processor may determine and/or calculate various scheduling characteristics of an identified upcoming compressed-mode gap, such as a start time of the gap, an end time of the gap, and a duration of the gap (i.e., the period of time between the start and end times of the gap). The device processor may further determine additional, contextual scheduling information for an identified upcoming compressed-mode gap related to one or more other identified upcoming compressed-mode gaps. For example, the device processor may determine the period of time between a start time of a first compressed-mode gap and a start time of a second compressed-mode gap that will occur before the first compressed-mode gap (e.g., a “wait_time” as described with reference to the data structure 702 of FIG. 7) and/or a period of time from the start time of the first compressed-mode gap to a start time of a third compressed-mode gap that will occur after the first compressed-mode gap. Thus, in such embodiments, the device processor may determine the timing/scheduling information for individual upcoming compressed-mode gaps, as well as generalized scheduling information for one or more groups of upcoming compressed-mode gaps.

In block 808, the device processor may generate at least one compressed-mode-gap event based on the scheduling information determined in block 806 for each of the at least one identified compressed-mode gaps. In some embodiments of the operations performed in block 808, the device processor may store the scheduling information determined in block 806 for the at least one identified compressed-mode gap in a data structure (e.g., the CMG_Event object data structure 702 of FIG. 7) maintained in memory (e.g., the memory 214 of FIG. 2). For example, based on scheduling information for a particular identified compressed-mode gap, the device processor may create a CMG_Event object that is associated with a start time, end time, gap duration, etc. of that particular identified compressed-mode gap, among other things.

In block 810, the device processor may populate the list initialized in block 802 with the at least one compressed-mode-gap event generated in block 808 in an order based on the scheduling information determined in block 806 that is associated with each of the at least one compressed-mode-gap events. In other words, the device processor may add each generated compressed-mode-gap event to the list in the order in which the events are expected to occur, such as based on the start time associated with each event. For example, the first compressed-mode-gap event in the list may be associated with the compressed-mode gap scheduled to occur next in time, and the last compressed-mode-gap event in the list may be associated with the compressed-mode gap scheduled to occur last in time.

Thus, as described, by maintaining the compressed-mode-gap events in the list in this fashion, the device processor may easily identify the scheduling/timing characteristics of an upcoming compressed-mode gap that is anticipated to occur and, thus, may quickly schedule a second subscription to perform power-monitoring operations during that upcoming compressed-mode gap (or during a compressed-mode gap associated with another compressed-mode-gap event).

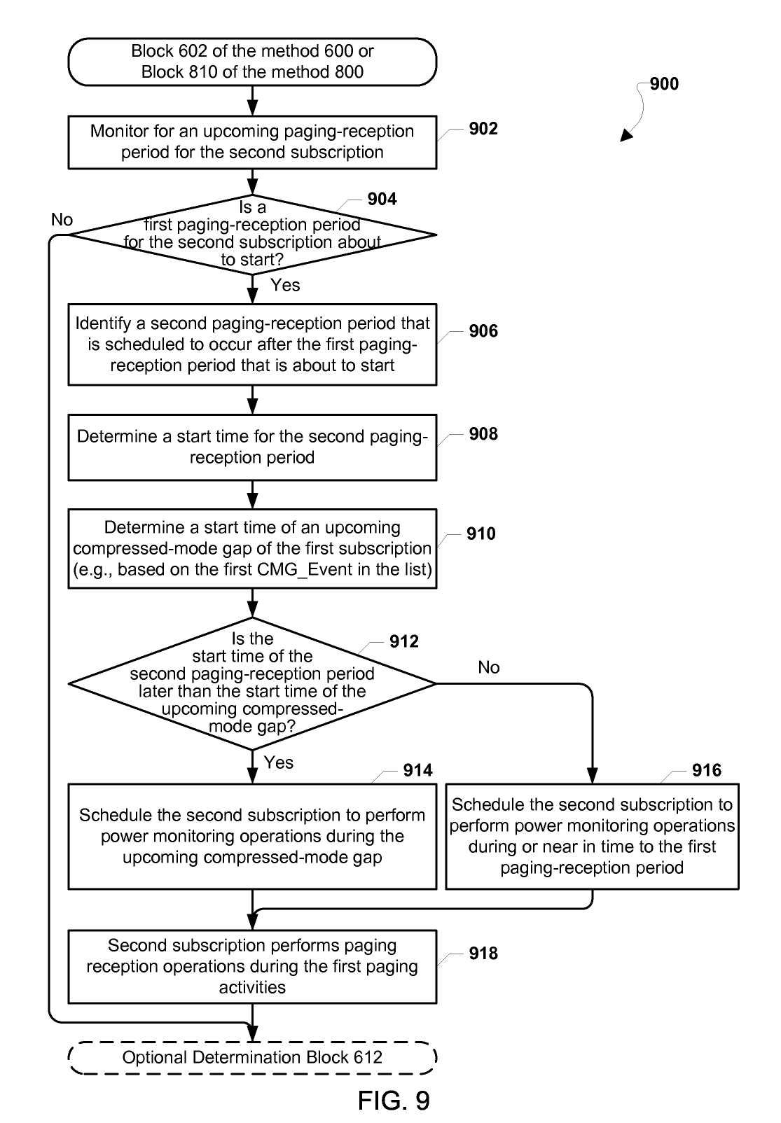

FIG. 9 illustrates a method 900 that may be implemented by a processor (e.g., the general purpose processor 206 of FIG. 2, the baseband modem processor 216, the power-monitoring scheduler unit 230, a separate controller, and/or the like) on a mobile communication device (e.g., the mobile communication device 200 of FIG. 2) for scheduling a second subscription to perform power-monitoring operations during an upcoming compressed-mode gap based on a start time of an upcoming compressed-mode gap of a first subscription. The operations of the method 800 implement some embodiments of the operations of the method 600 (FIG. 6). Thus, with reference to FIGS. 1-9, the device processor may begin performing the operations of the method 900 in response to receiving compressed-mode information for the first subscription from the first subscription's network in block 602 of the method 600. In some embodiments, the device processor may begin performing the operations of the method 900 in response to populating an ordered list of compressed-mode-gap events in block 810 of the method 800.

In block 902, the device processor may monitor for an upcoming paging-reception period for the second subscription, such as by referencing a schedule of paging-reception periods for the second subscription that are expected to occur in the future (i.e., a DRX cycle). For example, based on such a schedule, the device processor may determine a time at which the second subscription is next scheduled to start performing paging reception operations and may periodically (or continuously) compare that scheduled start time with a time currently observed on the mobile communication device. In some embodiments, the device processor may generate the second subscription's paging reception schedule based on information (e.g., DRX cycle timing information) received from the second subscription's mobile network. Additional (or alternatively), the device processor may receive paging-reception-timing information from the second subscription's network.

In determination block 904, the device processor may determine whether an upcoming paging-reception period for the second subscription (i.e., a first paging-reception period) is about to start. For example, the device processor may determine whether the scheduled start time of an upcoming paging-reception period is within a certain time threshold of the current time observed on the mobile communication device.

In response to determining that an upcoming paging-reception period for the second subscription is about to start (i.e., determination block 904=“Yes”), the device processor may identify a paging-reception period that is scheduled to occur after the upcoming paging-reception period that is about to start in block 906. In other words, in response to determining that the first paging-reception period is about to start in determination block 904, the device processor may identify a second paging-reception period that occurs after the first upcoming paging reception is scheduled to occur, in block 906.

In block 908, the device processor may determine a start time for the second paging-reception period. In some embodiments, the device processor may determine, obtain, and/or retrieve a DRX cycle length associated with the second subscription—i.e., the length of time between the second subscription's paging-reception periods' start times—and may calculate the start time of the second paging-reception period based on the start time of the first paging-reception period and the DRX cycle length. For example, the device processor may determine the start time of the first paging-reception period and may add the DRX cycle length to that start time to produce the start time of the second paging-reception period.

The device processor may determine a start time of an upcoming compressed-mode gap of the first subscription, in block 910, such as by referencing compressed-mode information received from the first subscription's network in block 602 of the method 600 (see FIG. 6). In some embodiments, the operations of block 910 may implement embodiments of the operations the block 608 of the method 600 (see FIG. 6), such that identifying an upcoming compressed-mode gap of the first subscription in block 608 may include determining a start time of the upcoming compressed-mode gap.

In some embodiments in which the device processor has initialized and populated an ordered list of compressed-mode-gap events that includes scheduling information for upcoming compressed-mode gaps (see, e.g., FIG. 8), the device processor may access the start time information associated with the first compressed-mode-gap event included in the list. In an example in which the ordered list is a CMG_Event List object, the device processor may access the list's “first_CMG_Event” field to identify the first CMG_Event object in the list and may reference the “time_of_gap” field in the first CMG_Event object to determine the start time of the compressed-mode gap associated with the first CMG_Event object.

In some embodiments, because the list is ordered based on the scheduling/start-time information associated with each compressed-mode-gap event, the first compressed-mode-gap event in the list may be associated with the compressed-mode gap that is expected to occur next. Further, in such embodiments, the device processor may routinely update the list to ensure that the first compressed-mode-gap event in the list is always associated with the next expected compressed-mode gap (e.g., as described with reference to FIG. 10).

In determination block 912, the device processor may determine whether the start time of the second paging-reception period determined in block 908 is later than the start time of the upcoming compressed-mode gap as determined in block 910. In some embodiments, the device processor may compare the start times of the second paging-reception period and the upcoming compressed-mode gap to determine whether a compressed-mode gap will occur before the second subscription must perform paging reception operations during the second paging-reception period.

In response to determining that the start time of the second paging-reception period is later than the start time of the upcoming compressed-mode gap (i.e., determination block 912=“Yes”), the device processor may schedule the second subscription to perform power-monitoring operations during the upcoming compressed-mode gap in block 914. In other words, the device processor may opportunistically schedule the second subscription's power-monitoring operations to occur while the first subscription is not transmitting during a compressed-mode gap, thereby avoiding the need for the first subscription to perform Tx blanking during the second subscription's power-monitoring operations while ensuring that those power-monitoring operations are not adversely affected by the first subscription's transmissions. As described, since the first subscription is scheduled to cease transmissions during the compressed-mode gap regardless of the second subscription's idle-standby mode operations, scheduling the second subscription to perform power-monitoring operations during the compressed-mode gap will cause the first subscription to experience an overall improved performance and throughput in comparison to conventional implementations that typically require the first subscription to implement Tx blanking during the second subscription's power-monitoring operations.

In response to determining that the start time of the identified paging-reception period is not later than the start time of the upcoming compressed-mode gap (i.e., determination block 912=“No”), the device processor may schedule the second subscription to perform power-monitoring operations during (or near in time) to the upcoming paging-reception period in block 916. In some embodiments of the operations performed in block 916, the device processor may schedule the second subscription to perform paging reception and power-monitoring operations to ensure that the second subscription's power-monitoring operations are performed within a reasonable time (i.e., before the start time of the second paging-reception period).

In response to scheduling the second subscription to perform power-monitoring operations during the upcoming compressed-mode gap in block 914 or in response to scheduling the second subscription to perform power-monitoring operations during (or near in time to) the upcoming paging-reception period in block 916, the second subscription may perform paging reception operations during the upcoming paging-reception period in block 918, such as by receiving paging messages from the second subscription's network using known techniques.

The device processor may continue performing operations in optional determination block 612 of the method 600 by determining whether the first subscription has entered an idle-standby mode or whether the second subscription has entered an active mode, as described (see FIG. 6).

FIG. 10 illustrates a method 1000 that may be implemented by a processor (e.g., the general purpose processor 206 of FIG. 2, the baseband modem processor 216, the power-monitoring scheduler unit 230, a separate controller, and/or the like) on a mobile communication device (e.g., the mobile communication device 200 of FIG. 2) for updating an ordered list of compressed-mode-gap events. The operations of the method 1000 implement some embodiments of the operations of the method 800 (e.g., as described with reference to FIG. 8). Thus, with reference to FIGS. 1-10, the device processor may begin performing the operations of the method 1000 in response to populating the ordered list of compressed-mode-gap events in block 810 of the method 600.

In some embodiments, the device processor may continually update the list of compressed-mode-gap events by removing events that have already occurred as those events may no longer be relevant or useful in scheduling the second subscription's power-monitoring operations to occur during the first subscription's compressed-mode gaps. In other words, after a scheduled compressed-mode gap has occurred, information stored in a compressed-mode-gap event in the list may be discarded to free up space and other resources for storing and processing upcoming compressed-mode-gap events.

Thus, in response to populating the list in block 810 of the method 800, the device processor may optionally wait a predetermined period of time in optional block 1002. In such embodiments, the device processor may periodically (rather than continuously) check whether a compressed-mode-gap event is out of date (i.e., has occurred) to conserve power and processing resources.

In determination block 1004, the device processor may determine whether a compressed-mode-gap event in the list of compressed-mode-gap events has occurred. In some embodiments of the operations performed in determination block 1004, the device processor may determine whether the current time is after a start time (or an end time) associated with a compressed-mode-gap event. In some embodiments, the device processor may analyze the compressed-mode-gap events stored in the list in the order in which they appear in the list. For example, the device processor may first determine whether the first compressed-mode-gap-event in the list has occurred as the first compressed-mode-gap-event may have the earliest start time.

In response to determining that a compressed-mode-gap event in the list of compressed-mode-gap events has not occurred (i.e., determination block 1004=“No”), the device processor may repeat the above operations in a loop by, optionally, waiting another predetermined period of time in optional block 1002. In response to determining that a compressed-mode-gap event in the list of compressed-mode-gap events has occurred (i.e., determination block 1004=“Yes”), the device processor may remove the compressed-mode-gap event determined to have occurred from the list, in block 1006. In some embodiments, the device processor may remove the compressed-mode-gap event from the list, such as by deleting that event and updating references to the deleted event. For example, the device processor may remove the first compressed-mode-gap event from the list and may update the “first_CMG_Event” field of the CMG_Event_List object (see FIG. 7) to reflect that the second compressed-mode-gap event is now the first event in the list. Thus, in such embodiments, the device processor may ensure that the list of compressed-mode-gap events is up-to-date and helpful in scheduling the second subscription's power-monitoring operations.

In optional determination block 612, the device processor may determine whether the first subscription has entered an idle-standby mode or whether the second subscription has entered an active mode by performing operations similar to those operations described with reference to optional determination block 612 of the method 600 (see FIG. 6). Thus, in response to determining that the first subscription has entered an idle-standby mode or that the second subscription has entered an active mode (i.e., optional determination block 612=“Yes”), the device processor may terminate operations.

In response to determining that the first subscription has not entered an idle-standby mode and that the second subscription has not entered an active mode (i.e., optional determination block 612=“No”), the device processor may repeat the above operations in optional block 1002 in a loop by again waiting a predetermined period of time in optional block 1002 before determining whether another compressed-mode-gap event in the list of compressed-mode-gap events has occurred in determination block 1004.

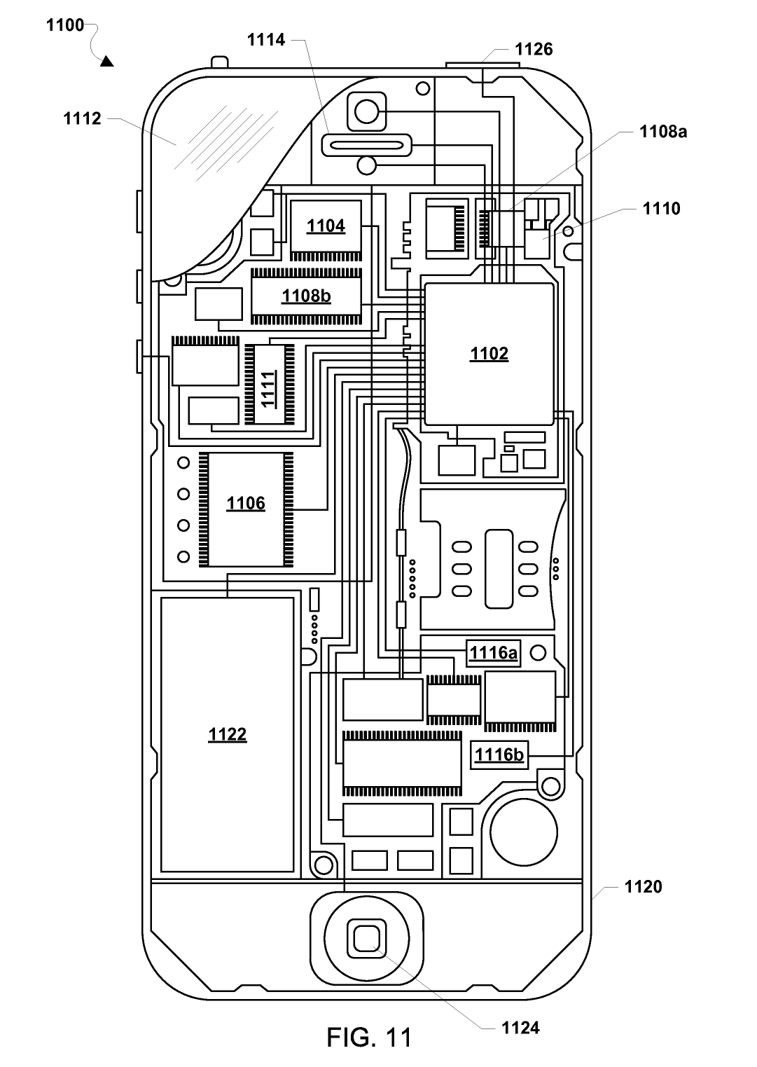

Various embodiments may be implemented in any of a variety of mobile communication devices, an example of which (e.g., a mobile communication device 1100) is illustrated in FIG. 11. According to various embodiments, the mobile communication device 1100 may be similar to the mobile communication devices 110, 120, 200 as described above with reference to FIGS. 1-3. As such, the mobile communication device 1100 may implement the methods 600, 800, 900, 1000 of FIGS. 6, 8-10.

The mobile communication device 1100 may include a processor 1102 coupled to a touchscreen controller 1104 and an internal memory 1106. The processor 1102 may be one or more multi-core integrated circuits designated for general or specific processing tasks. The internal memory 1106 may be volatile or non-volatile memory, and may also be secure and/or encrypted memory, or unsecure and/or unencrypted memory, or any combination thereof. The touchscreen controller 1104 and the processor 1102 may also be coupled to a touchscreen panel 1112, such as a resistive-sensing touchscreen, capacitive-sensing touchscreen, infrared sensing touchscreen, etc. Additionally, the display of the mobile communication device 1100 need not have touch screen capability.

The mobile communication device 1100 may have one or more cellular network transceivers 1108a, 1108b coupled to the processor 1102 and to two or more antennae 1110, 1111 and configured for sending and receiving cellular communications. The transceivers 1108a, 1108b and antennae 1110, 1111 may be used with the above-mentioned circuitry to implement the various embodiment methods. The mobile communication device 1100 may include two or more SIM cards 1116a, 1116b coupled to the transceivers 1108a, 1108b and/or the processor 1102 and configured as described above. The mobile communication device 1100 may include a cellular network wireless modem chip that enables communication via a cellular network and is coupled to the processor.

The mobile communication device 1100 may also include speakers 1114 for providing audio outputs. The mobile communication device 1100 may also include a housing 1120, constructed of a plastic, metal, or a combination of materials, for containing all or some of the components discussed herein. The mobile communication device 1100 may include a power source 1122 coupled to the processor 1102, such as a disposable or rechargeable battery. The rechargeable battery may also be coupled to the peripheral device connection port to receive a charging current from a source external to the mobile communication device 1100. The mobile communication device 1100 may also include a physical button 1124 for receiving user inputs. The mobile communication device 1100 may also include a power button 1126 for turning the mobile communication device 1100 on and off.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method implemented on a mobile communication device for scheduling power-monitoring operations of a second subscription to improve performance of a first subscription, comprising:
identifying an upcoming compressed-mode gap of the first subscription; and
scheduling the second subscription to perform power-monitoring operations during the upcoming compressed-mode gap of the first subscription.

2. The method of claim 1, wherein:
the first subscription is operating in an active mode; and
the second subscription is operating in an idle-standby mode.

3. The method of claim 1, wherein:
the first subscription utilizes a WCDMA radio access technology (RAT) to communicate with a WCDMA mobile network; and
the second subscription utilizes a GSM RAT to communicate with a GSM mobile network.

4. The method of claim 1, wherein:
the first subscription utilizes at least one of an Orthogonal Frequency-Division Multiple Access (OFDMA) and an LTE radio access technology (RAT) to communicate with an LTE mobile network; and
the second subscription utilizes a GSM RAT to communicate with a GSM mobile network.

5. The method of claim 1, wherein
the first subscription utilizes a first radio access technology (RAT) to communicate with a first mobile network;
the second subscription utilizes a second RAT to communicate with a second mobile network; and
the first RAT is different from the second RAT.

6. The method of claim 1, wherein:
identifying an upcoming compressed-mode gap of the first subscription further comprises determining a start time of the upcoming compressed-mode gap of the first subscription; and
scheduling the second subscription to perform power-monitoring operations during the upcoming compressed-mode gap of the first subscription comprises:
identifying a second paging-reception period of the second subscription that is scheduled to occur after a first paging-reception period of the second subscription, in response to determining that the first paging-reception period is about to start;
determining a start time of the second paging-reception period;
determining whether the start time of the second paging-reception period is later than the start time of the upcoming compressed-mode gap of the first subscription; and
scheduling the second subscription to perform power-monitoring operations during the upcoming compressed-mode gap of the first subscription in response to determining that the start time of the second paging-reception period is later than the start time of the upcoming compressed-mode gap of the first subscription.

7. The method of claim 6, further comprising scheduling the second subscription to perform power-monitoring operations near in time to the first paging-reception period in response to determining that the start time of the second paging-reception period is not later than the start time of the upcoming compressed-mode gap of the first subscription.

8. The method of claim 1, wherein identifying an upcoming compressed-mode gap of the first subscription comprises:
receiving compressed-mode information for the first subscription from a network of the first subscription; and
identifying the upcoming compressed-mode gap of the first subscription based on the received compressed-mode information.

9. The method of claim 8, further comprising:
determining whether updated compressed-mode information for the first subscription is available from the network of the first subscription; and
receiving the updated compressed-mode information from the network in response to determining that the updated compressed-mode information for the first subscription is available from the network of the first subscription.

10. The method of claim 1, further comprising:
receiving compressed-mode information for the first subscription from a network of the first subscription;
initializing a list of compressed-mode-gap events;
identifying an upcoming compressed-mode gap based on the received compressed-mode information;
determining scheduling information for the identified upcoming compressed-mode gap; and
generating a compressed-mode-gap event and adding the generated compressed-mode-gap event to the list, based on the determined scheduling information for the identified upcoming compressed-mode gap.

11. The method of claim 10, further comprising:
determining whether the compressed-mode-gap event in the list has occurred; and
removing the compressed-mode-gap event from the list in response to determining that the compressed-mode-gap event has occurred.

12. The method of claim 11, wherein determining whether the compressed-mode-gap event in the list has occurred comprises:
waiting a predetermined period of time; and
determining whether the compressed-mode-gap event in the list has occurred in response to waiting the predetermined period of time.

13. The method of claim 10, wherein:
identifying an upcoming compressed-mode gap of the first subscription comprises determining a start time associated with a compressed-mode-gap event that is ordered first in the list; and
scheduling the second subscription to perform power-monitoring operations during the identified upcoming compressed-mode gap of the first subscription comprises:
identifying a second paging-reception period of the second subscription that is schedule to occur after a first paging-reception period of the second subscription in response to determining that the first paging-reception period is about to start;
determining a start time of the second paging-reception period;
determining whether the start time of the second paging-reception period is later than the start time associated with the compressed-mode-gap event ordered first in the list; and
scheduling the second subscription to perform power-monitoring operations during a compressed-mode gap associated with the compressed-mode-gap event that is ordered first in the list in response to determining that the start time of the second paging-reception period is later than the start time associated with the compressed-mode-gap event ordered first in the list.

14. The method of claim 13, further comprising scheduling the second subscription to perform power-monitoring operations near in time to the first paging-reception period in response to determining that the start time of the second paging-reception period is not later than the start time associated with the compressed-mode-gap event ordered first in the list.

15. A mobile communication device, comprising:
a plurality of radio-frequency (RF) chains; and
a processor coupled to the plurality of RF chains, wherein the processor is configured to:
identify an upcoming compressed-mode gap of a first subscription; and
schedule a second subscription to perform power-monitoring operations during the upcoming compressed-mode gap of the first subscription.

16. The mobile communication device of claim 15, wherein:
the first subscription is operating in an active mode; and
the second subscription is operating in an idle-standby mode.

17. The mobile communication device of claim 15, wherein:
the first subscription utilizes a WCDMA radio access technology (RAT) to communicate with a WCDMA mobile network; and
the second subscription utilizes a GSM RAT to communicate with a GSM mobile network.

18. The mobile communication device of claim 15, wherein:
the first subscription utilizes at least one of an Orthogonal Frequency-Division Multiple Access (OFDMA) and an LTE radio access technology (RAT) to communicate with an LTE mobile network; and
the second subscription utilizes a GSM RAT to communicate with a GSM mobile network.

19. The mobile communication device of claim 15, wherein
the first subscription utilizes a first radio access technology (RAT) to communicate with a first mobile network;
the second subscription utilizes a second RAT to communicate with a second mobile network; and
the first RAT is different from the second RAT.

20. The mobile communication device of claim 15, wherein the processor is further configured to:
determine a start time of the upcoming compressed-mode gap of the first subscription;
identify a second paging-reception period of the second subscription that is scheduled to occur after a first paging-reception period of the second subscription in response to determining that the first paging-reception period is about to start;
determine a start time of the second paging-reception period;
determine whether the start time of the second paging-reception period is later than the start time of the upcoming compressed-mode gap of the first subscription; and
schedule the second subscription to perform power-monitoring operations during the upcoming compressed-mode gap of the first subscription in response to determining that the start time of the second paging-reception period is later than the start time of the upcoming compressed-mode gap of the first subscription.

21. The mobile communication device of claim 20, wherein the processor is further configured to schedule the second subscription to perform power-monitoring operations near in time to the first paging-reception period in response to determining that the start time of the second paging-reception period is not later than the start time of the upcoming compressed-mode gap of the first subscription.

22. The mobile communication device of claim 15, wherein the processor is further configured to:
receive compressed-mode information for the first subscription from a network of the first subscription; and
identify the upcoming compressed-mode gap of the first subscription based on the received compressed-mode information.

23. The mobile communication device of claim 22, wherein the processor is further configured to:
determine whether updated compressed-mode information for the first subscription is available from the network of the first subscription; and
receive the updated compressed-mode information from the network in response to determining that the updated compressed-mode information for the first subscription is available from the network of the first subscription.

24. The mobile communication device of claim 15, wherein the processor is further configured to:
receive compressed-mode information for the first subscription from a network of the first subscription;
initialize a list of compressed-mode-gap events;
identify an upcoming compressed-mode gap based on the received compressed-mode information;
determine scheduling information for the identified upcoming compressed-mode gap; and
generate a compressed-mode-gap event and adding the generated compressed-mode-gap event to the list, based on the determined scheduling information for the identified upcoming compressed-mode gap.

25. The mobile communication device of claim 24, wherein the processor is further configured to:
determine whether the compressed-mode-gap event in the list has occurred; and
remove the compressed-mode-gap event from the list in response to determining that the compressed-mode-gap event has occurred.

26. The mobile communication device of claim 25, wherein the processor is further configured to:
wait a predetermined period of time; and
determine whether the compressed-mode-gap event in the list has occurred in response to waiting the predetermined period of time.

27. The mobile communication device of claim 24, wherein the processor is further configured to:
determine a start time associated with a compressed-mode-gap event that is ordered first in the list;
identify a second paging-reception period of the second subscription that is schedule to occur after a first paging-reception period of the second subscription in response to determining that the first paging-reception period is about to start;
determine a start time of the second paging-reception period;
determine whether the start time of the second paging-reception period is later than the start time associated with the compressed-mode-gap event ordered first in the list; and
schedule the second subscription to perform power-monitoring operations during a compressed-mode gap associated with the compressed-mode-gap event that is ordered first in the list in response to determining that the start time of the second paging-reception period is later than the start time associated with the compressed-mode-gap event ordered first in the list.

28. The mobile communication device of claim 27, wherein the processor is further configured to schedule the second subscription to perform power-monitoring operations near in time to the first paging-reception period in response to determining that the start time of the second paging-reception period is not later than the start time associated with the compressed-mode-gap event ordered first in the list.

29. A non-transitory processor-readable storage medium having stored thereon processor-executable instructions configured to cause a processor of a mobile communication device to perform operations comprising:
identifying an upcoming compressed-mode gap of a first subscription; and
scheduling a second subscription to perform power-monitoring operations during the upcoming compressed-mode gap of the first subscription.

30. A mobile communication device, comprising:
means for identifying an upcoming compressed-mode gap of a first subscription; and
means for scheduling a second subscription to perform power-monitoring operations during the upcoming compressed-mode gap of the first subscription.
